(19) United States
(12) Patent Application Publication
(10) Pub. No.: US 2026/0044751 A1
(43) Pub. Date: Feb. 12, 2026

(54) DATA MODEL GENERATION UTILIZING A UNIVERSAL KNOWLEDGE GRAPH AND LARGE LANGUAGE MODEL TECHNIQUES

(71) Applicant: Sisense Ltd., Ramat Gan (IL)

(72) Inventors: Avi GRUSHKA, Tel Aviv (IL); Yael LEV, Tenafly, NJ (US)

(73) Assignee: Sisense Ltd., Ramat Gan (IL)

(21) Appl. No.: 18/800,760

(22) Filed: Aug. 12, 2024

(51) Int. Cl. G06N 5/022; G06N 3/042; G06N 3/0475

(52) U.S. Cl. CPC G06N 5/022; G06N 3/042; G06N 3/0475

(57) ABSTRACT

A system and method for providing query responses from a big data system utilizing a knowledge graph is presented. The method includes generating a plurality of local knowledge graphs, each local knowledge graph of the plurality of local knowledge graphs generated respective of a unique plurality of data sources; generating a universal knowledge graph based on the generated plurality of local knowledge graphs; fine-tuning a large language model (LLM) based on the generated universal knowledge graph; receiving a query directed at a data source of the plurality of unique data sources of a first local knowledge graph; generating a prompt for the LLM based on the received query; and processing the prompt utilizing the LLM to generate an output, wherein the output is a response to the received query.

### TECHNICAL FIELD

The present disclosure relates generally to data model querying and specifically to querying data utilizing knowledge graphs and large language models.

### BACKGROUND

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, the method may include generating a plurality of local knowledge graphs, each local knowledge graph of the plurality of local knowledge graphs generated respective of a unique plurality of data sources. The method may also include generating a universal knowledge graph based on the generated plurality of local knowledge graphs. The method may furthermore include fine-tuning a large language model (LLM) based on the generated universal knowledge graph. The method may in addition include receiving a query directed at a data source of the plurality of unique data sources of a first local knowledge graph. The method may moreover include generating a prompt for the LLM based on the received query. The method may also include processing the prompt utilizing the LLM to generate an output, where the output is a response to the received query. Other embodiments of this aspect include corresponding computer systems, apparatus, and computer programs recorded on one or more computer storage devices, each configured to perform the actions of the methods.

Implementations may include one or more of the following features. The method may include: generating the first local knowledge graph of the plurality of local knowledge graphs based on a first plurality of queries directed to the unique plurality of data sources of the first local knowledge graph; generating a second local knowledge graph of the plurality of local knowledge graphs based on a second plurality of queries directed to the unique plurality of data sources of the second local knowledge graph. The method may include: generating the prompt further based on the first local knowledge graph. The method where the prompt is generated using a retrieval augmented generation (RAG) technique. The method may include: adapting a weight of an output layer neuron of the LLM based on a weight of a node of the universal knowledge graph. The method may include: fine-tuning a second LLM based on the generated universal knowledge graph, where the second LLM is different from the LLM; processing the prompt utilizing the second LLM to generate a second output; comparing the output to the second output to determine a difference value; and providing the output in response to determining that the difference value is below a threshold value. The method may include: generating a request for a new query, in response to determining that the difference value is above a threshold value. The method may include: continuously updating the universal knowledge graph; and continuously fine-tuning the LLM based on the continuously updated universal knowledge graph. The method may include: accessing a new plurality of unique data sources; extracting metadata from each unique data source of the new plurality of unique data sources; generating a prompt for the LLM based on the extracted metadata, which when processed by the LLM outputs a shared data model for the new plurality of unique data sources. Implementations of the described techniques may include hardware, a method or process, or a computer tangible medium.

In one general aspect, non-transitory computer-readable medium may include one or more instructions that, when executed by one or more processors of a device, cause the device to: generate a plurality of local knowledge graphs, each local knowledge graph of the plurality of local knowledge graphs generated respective of a unique plurality of data sources; generate a universal knowledge graph based on the generated plurality of local knowledge graphs; fine-tune a large language model (LLM) based on the generated universal knowledge graph; receive a query directed at a data source of the plurality of unique data sources of a first local knowledge graph; generate a prompt for the LLM based on the received query; and process the prompt utilizing the LLM to generate an output, where the output is a response to the received query. Other embodiments of this aspect include corresponding computer systems, apparatus, and computer programs recorded on one or more computer storage devices, each configured to perform the actions of the methods.

In one general aspect, a system may include one or more processors configured to: generate a plurality of local knowledge graphs, each local knowledge graph of the plurality of local knowledge graphs generated respective of a unique plurality of data sources. A system may furthermore generate a universal knowledge graph based on the generated plurality of local knowledge graphs. A system may in addition fine-tune a large language model (LLM) based on the generated universal knowledge graph. A system may moreover receive a query directed at a data source of the plurality of unique data sources of a first local knowledge graph. A system may also generate a prompt for the LLM based on the received query. A system may furthermore process the prompt utilizing the LLM to generate an output, where the output is a response to the received query. Other embodiments of this aspect include corresponding computer systems, apparatus, and computer programs recorded on one or more computer storage devices, each configured to perform the actions of the methods.

Implementations may include one or more of the following features. A system where the one or more processors are further configured to: generate the first local knowledge graph of the plurality of local knowledge graphs based on a first plurality of queries directed to the unique plurality of data sources of the first local knowledge graph; and generate a second local knowledge graph of the plurality of local knowledge graphs based on a second plurality of queries directed to the unique plurality of data sources of the second local knowledge graph. A system where the one or more processors are further configured to: generate the prompt further based on the first local knowledge graph. A system where the prompt is generated using a retrieval augmented generation (RAG) technique. A system where the one or more processors are further configured to: adapt a weight of an output layer neuron of the LLM based on a weight of a node of the universal knowledge graph. A system where the one or more processors are further configured to: fine-tune a second LLM based on the generated universal knowledge graph, where the second LLM is different from the LLM; process the prompt utilizing the second LLM to generate a second output; compare the output to the second output to determine a difference value; and provide the output in response to determining that the difference value is below a threshold value. A system where the one or more processors are further configured to: generate a request for a new query, in response to determining that the difference value is above a threshold value. A system where the one or more processors are further configured to: continuously update the universal knowledge graph; and continuously fine-tune the LLM based on the continuously updated universal knowledge graph. A system where the one or more processors are further configured to: access a new plurality of unique data sources; extract metadata from each unique data source of the new plurality of unique data sources; and generate a prompt for the LLM based on the extracted metadata, which when processed by the LLM outputs a shared data model for the new plurality of unique data sources. Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1A is a relations diagram utilized to describe various disclosed embodiments.

FIG. 1B is an example diagram of a large language model query engine, utilized in accordance with an embodiment.

FIG. 2 is a schematic illustration showing an enriched layer of a universal knowledge graph applied to multiple local knowledge graph systems according to an embodiment.

FIG. 3 is an example illustration of a query structure.

FIG. 4 is a flow diagram illustrating a system for generating a semantic knowledge graph according to an embodiment.

FIG. 5 is a network diagram utilized to describe various disclosed embodiments.

FIG. 6 is an example flow diagram utilized to describe a query graph structure generated by a parser for a semantic knowledge graph generator.

FIG. 7 is a flowchart illustrating a method for generating a semantic knowledge graph from an event log of a BI system according to an embodiment.

FIG. 8 is a diagram of a fine-tuned LLM for generating a response to a data query, implemented in accordance with an embodiment.

FIG. 9 is a flowchart of a method for generating a query response utilizing a fine-tuned LLM, implemented in accordance with an embodiment.

FIG. 10 is an example schematic diagram of an LLM query engine according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The universal knowledge graph is utilized to generate a data visualization, which can be displayed to a user (e.g., via a graphical user interface). The data visualization may include one or more recommendations of connections between users indicated in one semantic knowledge graph and users indicated in another semantic knowledge graph.

In an embodiment, one or more of the semantic knowledge graphs are generated based on events recorded in an event log. Each event may be an access of data from a data source such as, but not limited to, executing a query, updating a report widget, and the like. Each event record is parsed to identify objects and relationships between the objects. The semantic graph is generated with nodes corresponding to the identified objects and edges corresponding to the identified relationships. Each edge may be further assigned a weight based on a number of appearances of the related objects together in the parsed records. A given pair of nodes may further have multiple edges between them.

The disclosed embodiments include techniques for using established knowledge graphs to generate dashboards for new users. A dashboard is a graphical user interface which includes one or more widgets, indicators, and the like. The widgets are individual interfaces which correspond to one or more queries executed on a data source. A widget may be a graphical representation such as a pie chart, graph, line chart, and the like. Initially, a dashboard may lack any widgets associated thereto.

In this regard, it is noted that one of the challenges in the field of business intelligence reports is that the abundance of data in data sources and the sheer size of data models creates difficulty for users when searching for data. More specifically, it is impractical for users to manually determine where to begin searching in large databases in order to maximize their search effectiveness. The disclosed embodiments provide users with initial dashboards prepopulated with one or more widgets that reduce the amount of input needed from a user in order to begin searching.

It should be noted that various embodiments described herein are discussed with respect to dashboards including example visualizations of data, but that the disclosed embodiments are not limited to any particular visualization. A dashboard may include, but is not limited to, instructions for rendering one or more widgets (each based on one or more queries) and an order in which the widgets should be rendered. Further, content-based visualizations as described herein are not limited to dashboards and may be implemented in other solutions such as, but not limited to, digest push notifications, visualizations integrated in third party software applications, and the like.

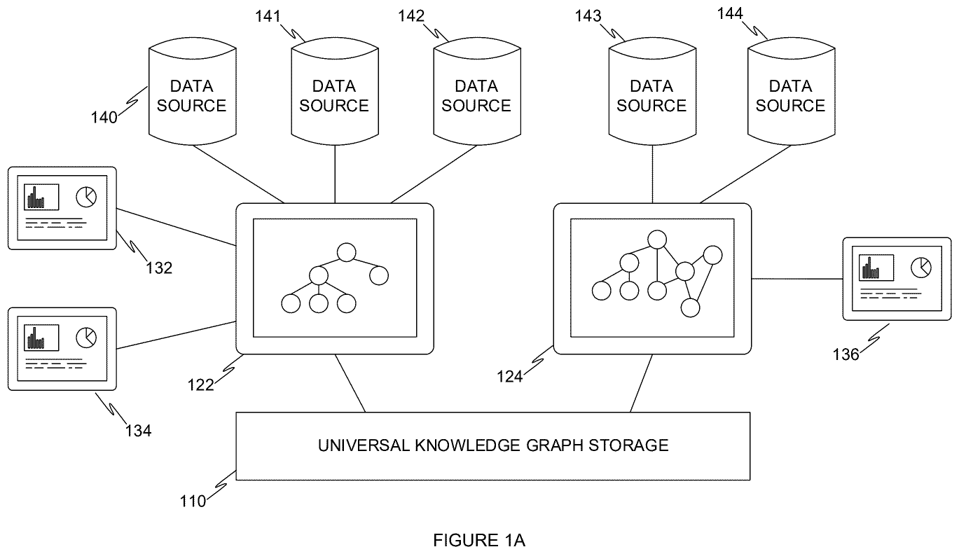

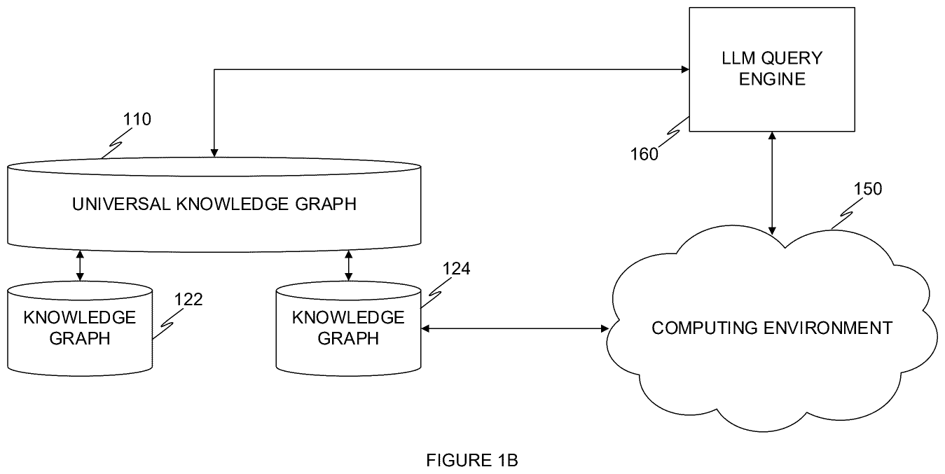

FIG. 1A is a relations diagram utilized to describe various disclosed embodiments. In the example communications diagram, a universal knowledge graph (UKG) system 110 communicates with a plurality of local knowledge graph systems. In an embodiment, such local knowledge graph systems include knowledge graph systems 122 and 124. Each local knowledge graph system is configured to store a knowledge graph generated based on interactions of different groups of users with corresponding user devices, different data sources, and the like, according to an embodiment. In some embodiments, the knowledge graph system 122 includes a knowledge graph which is generated based on interactions of user devices 132 and 134 with data sources 140, 141, 142, 143, and 144. In an embodiment, a graph is stored utilizing a graph database, such as Neo4j®.

According to an embodiment, an interaction is a communication with a data source that causes data to be accessed, manipulated, or both. In an embodiment, interactions include generating a query directed at a data source, at a plurality of data sources, initiating a build of a data cube based on data in data sources, a combination thereof, and the like.

In an embodiment, an interaction of a user device with a data source occurs in response to a user of a user device manipulating the user device to cause the user device to generate a request including at least an action with respect to the data source, for example via a user interface of an analytic application. In an embodiment, a user of the user device 132 causes the user device 132 to interact with the data source 140 by generating by the user device 132 a query directed to a set of data stored in the data source 140. In an embodiment, the data source includes a relational database, a graph database, a columnar database, a cloud-managed database, a data lake, a data warehouse, a distributed database, a combination thereof, and the like.

In some embodiments, each of the knowledge graphs 132, 134, and 136 include nodes representing objects. In certain embodiments the knowledge graphs further include edges connecting the nodes. In an embodiment, the nodes represent objects related to events and the edges represent relationships between those objects. To this end, the knowledge graphs 132, 134, and 136 are semantic knowledge graphs generated based on query objects described in an event log and relationships among those query objects indicated in events of the event log, according to an embodiment.

A universal knowledge graph system 110 is configured to generate a universal knowledge graph based on local knowledge graphs received from one or more sources. In an embodiment, the universal graph is generated based on multiple distinct sources such that a first source corresponds to a first customer account and a second source corresponds to a second, distinct, customer account. Each customer account includes one or more user accounts which share a common model, or which share a common model and common data source(s), according to an embodiment.

In some embodiments, each knowledge graph has a distinct structure, for example as defined by a data schema. The structure of a knowledge graph is affected by queries initiated by users or predetermined by the dashboard use, and by data and metadata at the data source, according to an embodiment. In an embodiment, the queries are initiated via a natural language query (NLQ) interface.

By generating universal knowledge graphs including and connected nodes from multiple local knowledge graphs, the universal knowledge graph system 110 effectively connects the different local knowledge graphs. In an embodiment, a connection between knowledge graphs is achieved by merging a plurality of knowledge graphs into a single graph. In another embodiment, the connection is achieved by generating an enriched data layer which connects at least a node in a first knowledge graph to at least a node in a second knowledge graph.

In an embodiment, the enriched data layer is a unified semantic representation of the queries which are used to generate the respective knowledge graphs of each customer account (i.e., the local knowledge graphs). In an embodiment, the nodes and edges of a first local graph and of a second local graph are merged together, forming a universal graph. In another embodiment, the first local graph and the second local graph may each be associated with one or more enriched data layers such that the first local graph, the second local graph, and the one or more enriched data layers collectively form the universal knowledge graph.

FIG. 1B is an example diagram of a large language model query engine, utilized in accordance with an embodiment. In an embodiment, a universal knowledge graph 110 is generated based on a plurality of knowledge graphs, such as local knowledge graph 122 and local knowledge graph 124.

In some embodiments, each local knowledge graph (e.g., 122 and 124) is updated periodically, continuously, etc. In an embodiment, the universal knowledge graph 110 is updated periodically, continuously, etc., based on an update of at least a local knowledge graph of a plurality of knowledge graphs.

In an embodiment, local knowledge graph 124 is generated based on queries, data sources, enrichments, and the like, of a first computing environment 150. In some embodiments, the computing environment 150 includes a plurality of data sources, resources, user devices, resources, a combination thereof, and the like.

In some embodiments, a large language model (LLM) query engine 160 is configured to provide results to structured queries, unstructured queries, a combination thereof, and the like, based on data sources related to the first computing environment 150. In an embodiment, the LLM query engine 160 includes an LLM, based on a GPT model, a BERT model, a LLAMA model, and the like.

According to an embodiment, the LLM is fine-tuned on the universal knowledge graph 110. In an embodiment, fine-tuning the LLM includes adjusting a weight associated with a neuron. In some embodiments, fine-tuning the LLM includes adjusting a weight associated with a neuron of an output layer of the LLM. In certain embodiments, the weight is adjusted based on a weight of an edge between two nodes in the universal knowledge graph.

In some embodiments, a prompt is generated for the LLM of the LLM query engine 160, for example based on a received query and a predefined prompt template. In some embodiments, the LLM is provided with a prompt which when processed by the LLM generates a prompt based on the received query and the predefined prompt template. The output of the LLM is then a prompt based on the predefined prompt template, adapted by the received query. In an embodiment, the query is a natural language query, a structured query, an unstructured query, a combination thereof, and the like.

According to certain embodiments, an input for the LLM is further utilized with a retrieval augmented generation (RAG) technique. For example, in an embodiment, the local knowledge graph of the computing environment is provided as a RAG input, while the universal knowledge graph is utilized to fine-tune the model.

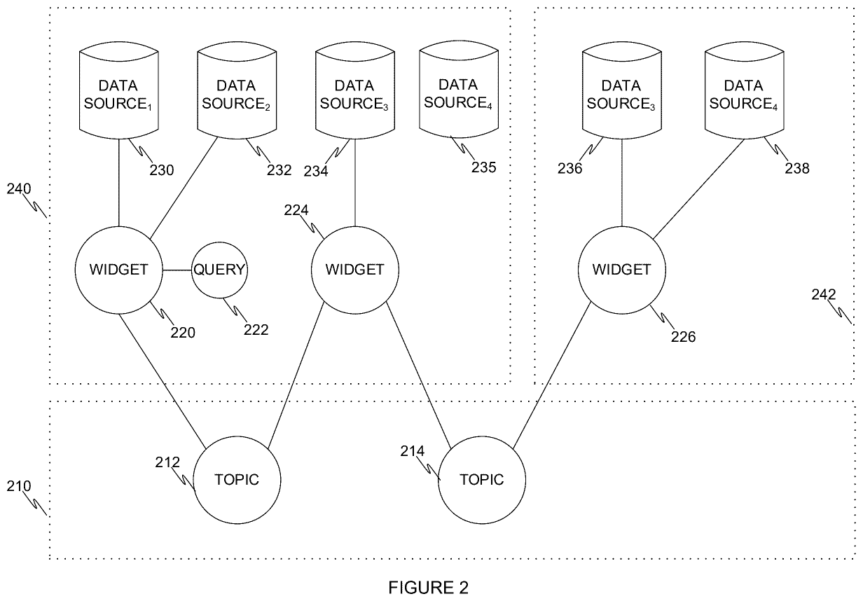

FIG. 2 is a schematic illustration 200 showing an enriched layer 210 of a universal knowledge graph applied to multiple local knowledge graph systems according to an embodiment.

An enriched data layer 210 includes a plurality of objects which are used to classify data. In the example shown in FIG. 2, a first object 212 and second object 214 are topic nodes. Each topic node is a node used to classify other nodes by topic. That is, a node connected to a topic node is considered to be related to a topic represented by the topic node. The topic nodes therefore provide a component of the enriched data layer which connect. A topic may be a word or combination of words, numbers, and the like. Example topics may include, but are not limited to, ‘sales’, ‘human resources’, ‘marketing’, and the like.

In an embodiment, the topic nodes may be the result of words embedded into a matrix of topic vectors. For example, a widget represented by a widget node 220 may be accessed to determine all words, strings, numbers, and the like, associated with the widget. In the example shown in FIG. 2, the widget node 220 is connected by an edge with a query node 222. The query node 222 represents a query which is executed on a data source 230 storing a first type of data and on a data source 232 storing a second type of data. The result of the query is presented on a dashboard via the widget node 220.

The query, metadata associated with the query node 222 representing the query, metadata associated with the widget 220, and metadata associated with the data source 230 and data source 232 are analyzed to determine a match between the query with one or more topics. A match may result in generating an edge between any of the aforementioned nodes and the relevant topic node. In an embodiment, the matching may be performed by word embedding. Such word embedding may include, but is not limited to, mathematical embedding from a first multiple-dimension per word space into a continuous vector space having a lower dimension than the first multiple dimension space. The result of the embedding may be used to determine a vector distance between a node and a topic node. An edge connecting a node to a topic node is generated if the distance vector between the node and the topic node is less than a predetermined threshold value. In the example shown in FIG. 2, widgets 220 and 224 are associated with a first dashboard and a first knowledge graph 240, and widget 226 is associated with a second dashboard and a second knowledge graph 242.

The enriched layer 210 includes a first topic node 212 and a second topic node 214. The widget 224 associated with the first dashboard and knowledge graph 240 and the widget 226 associated with the second dashboard and knowledge graph 242 are each connected via a respective edge to the topic node 214. In the example shown in FIG. 2, the universal knowledge graph 110 would determine that the widgets 224 and 226 are similar based on a determination that the data source 234 (which is connected to the widget 224) is of a certain type and the data source 236 (which is connected to the widget 226) is likewise of the same type.

In this regard, it is noted that data sources are not necessarily formatted in the same way such that queries to different data sources may appear to be different even though the actual content of the data being queried or the content being queried for is very similar. In particular, this may affect attempts to connect nodes representing queries to different data sources. The disclosed embodiments therefore utilize the types of data stored by the respective data sources in order to determine which nodes of a universal knowledge graph are to be connected to nodes of different local knowledge graphs.

Other attributes may be used to determine similarity. Such attributes may include, but are not limited to, queries that are associated with the widgets, various metadata (e.g., metadata of nodes of knowledge graphs) as mentioned above, tables stored on the data sources, and the like. Similarity can be based on data structure.

By providing a universal knowledge graph linking nodes representing queries related to different data sources, the disclosed embodiments allow for providing insights about how data may be used by other users. For example, a widget related to Human Resources (e.g., a widget configured to determine average overtime paid) may be monitored by multiple different organizations utilizing similar queries. When a new user of the BI system monitors widgets related to ‘Human Resource’ topics, a widget of ‘average overtime paid’ may be suggested to them, thereby increasing the value they receive from the system, as this provides an insight which they would not otherwise have gained.

One advantage of the proposed solution is the ability to generate a suggestion to a user of the first dashboard to connect a data source 235 of a fourth type to the widget 224, since this type of connection is present between data source 238 and widget 226. As noted above, this may provide additional benefit and allow a user to achieve insights which might not otherwise be readily available. A business intelligence system utilizing the disclosed embodiments is therefore clearly advantageous over business intelligence systems that generate queries or recommendations without identifying potential connections between nodes related to different data sources.

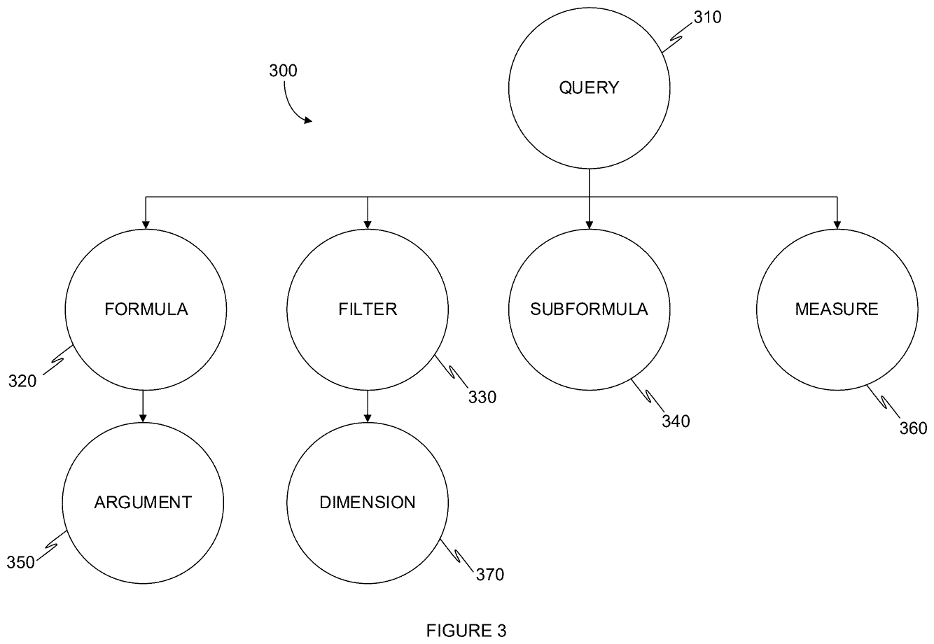

FIG. 3 is an example illustration of a query structure 300. In the example implementation shown in FIG. 3, the query structure 300 includes one or more formulae 320, a filter 330, one or more sub-formulae 340, an argument 350, a measure 360, and a dimension 370.

In an embodiment, a query 310 is connected to a formula 320, a filter 330, a sub-formula 340, a measure 360, and a combination thereof. Each formula 320 may be a higher degree of one of the sub-formulae 340. The query graph structure 300 may be used to represent any query in a graph structure including nodes and connections. The connections may be relations between the nodes represented as edges in the graph structure. Throughout this disclosure, relations, relationships, edges and links are all used interchangeably with regards to nodes and vertices. The formulae 320, measure 360, or dimension 370 may be used for filtering by filter 330. It is readily understood that a formula may have a filter in a sub-formula thereof.

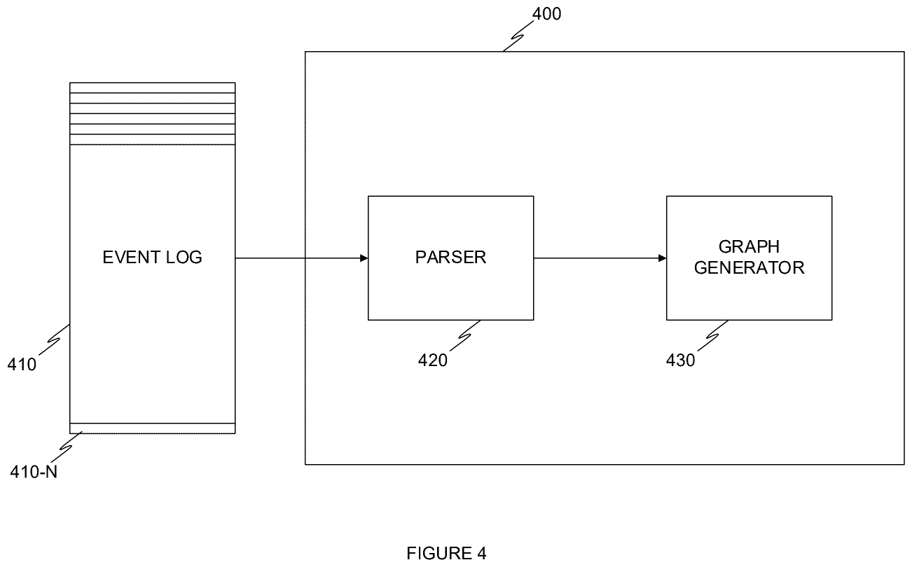

FIG. 4 is a flow diagram illustrating a system 400 for generating a semantic knowledge graph according to an embodiment. The system 400 is configured to receive one or more event logs 410. An event log 410 includes a plurality of events such as event 410-N (where ‘N’ is an integer having a value of ‘2’ or greater). Each event is generated in response to instructions executed with respect to a dashboard, according to an embodiment.

In certain embodiments, event logs may record events which are generated in response to executing instructions on a data source such as, for example, executing a structured query language (SQL) query on a database. As a non-limiting example, a dashboard user interface may request to execute a JAQL (JSON query language) expression with respect to a BigData data source. The JAQL expression is then stored in the event log 410.

The event log 410 may also store events such as, but not limited to, a request to change a temporal view of a widget, a request to filter data in a widget, a request to perform an active or passive instruction, and the like. A passive instruction is performed automatically. For example, when loading a dashboard, certain queries are to be executed in order to at least initially populate the widget with data results. Active instructions may be queries requested by a user, filtered views request by the user, and the like.

The event log 410 is fed into a parser 420. The parser 420 is configured to receive one or more events of the event log and to parse the events into a data format for the graph generator 430. The parser 420 may be further configured to detect objects within an event. An object may be, but is not limited to, a formula, filter, argument, element, or sub-formula, for example as shown in FIG. 3 above. The parser 420 may be further configured to determine a relationship between one or more objects based on the event.

In some implementations, the relationship between objects may be defined with respect to a hierarchy. Further, the hierarchy may be directional (i.e., top to bottom or vice-versa) such that relationships may be further defined with respect to the direction from one node to another in a hierarchy. As a non-limiting example, a node representing “Alice” may be higher in a hierarchy than a node representing “Bob” such that the relationship between “Alice” and “Bob” is “parent-child”. A hierarchy may also be determined based on metadata of the data sources.

It is important to note that the semantic knowledge graph may be generated without access to the data itself by accessing the event log, metadata of the data source(s), or a combination thereof. This may be useful if a graph is being generated either by or for a third party which is not privy to the underlying data.

The graph generator 430 is configured to generate semantic knowledge graphs based on the parsed event logs. For example, the graph generator 430 may be configured to detect a first object having a relationship to a second object. The graph generator 430 may further be configured to assign a weight to the relationship. In this example, the first object may appear once with a “SUM” relationship to the second object, and eleven instances with an “AVG” relationship to the second object. Therefore the “AVG” relationship would carry a higher weight.

In an embodiment, the graph generator 430 may be configured to generate a graph based on all possible relationships between all detected objects. The graph generator 430 is configured to assign weights to each relationship based on the relations extracted and parsed from the event log 410. In some embodiments, one or more relations of the semantic knowledge graph can be based on interactions of one or more users with the system 400. For example, an event log may indicate a user which performed or requested to perform certain operations. Two objects may have a relationship having a first weight from the perspective of a first user, and a second weight from the perspective of a second user.

In another embodiment, a semantic knowledge graph may be generated with respect to a user based at least partially on events which the user (e.g., via a user account or user device) initiated. In certain embodiments, a semantic knowledge graph may be generated based on the event logs of multiple users such as, but not limited to, users who belong to a certain organization or group within an organization. The weights attached to the relations in the semantic knowledge graph may be default set weights. The default weights can be then adjusted for each existing or new user by the system 400 based on events generated by the user. This allows for retention of some organizational memory as well as for customization of a user's experience of a user accessing a BI system. In some embodiments, the graph generator 430 may be further configured to generate a graph for a user account based on permissions of the user. For example, a certain user may be unauthorized to view data associated with certain objects, in which case the graph generator 430 may determine to preclude a corresponding node from the graph provided to that user.

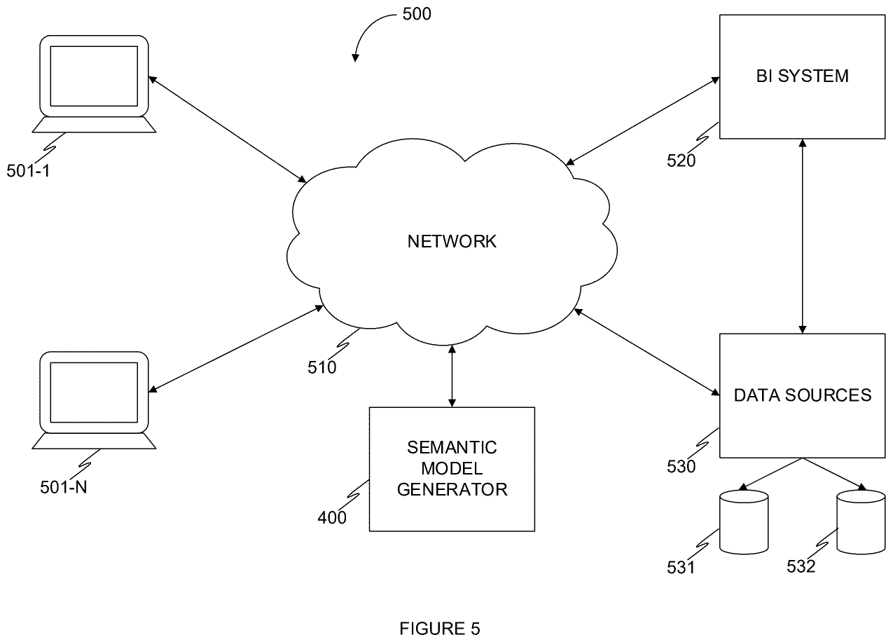

FIG. 5 is a network diagram 500 utilized to describe various disclosed embodiments. A plurality of user devices 501-1 through 501-N (where ‘N’ is an integer having a value of ‘2’ or greater) are communicatively connected to a network 510.

The network 510 may be, but is not limited to, a wireless, cellular or wired network, a local area network (LAN), a wide area network (WAN), a metro area network (MAN), the Internet, the worldwide web (WWW), similar networks, and any combination thereof. The network 510 further provides communicative connectivity for the semantic model generator system 400, for a business intelligence (BI) system 520, and one or more data sources 530.

In the example network diagram 500, the data sources 530 include a first database 531 and a second database 532. In an embodiment, the BI system 520 is configured to generate a dashboard user interface. According to an embodiment, the BI system 520 is communicatively connected to the data source 530 either directly or via the network 510. In an example implementation, the BI system 520 and the system 400 may be part of the same LAN.

The BI system 520 is configured to supply the client devices 501 with a dashboard user interface, and further to receive instructions (or requests) to execute queries with respect to the data sources 530. In some embodiments, the BI system 520 is configured to allow the system 500 to access an event log 410 stored therein. In other embodiments, the event log may be stored on the system 400, for example by configuring a client device (not shown) to send each instruction to both the system 400 and the BI system 520.

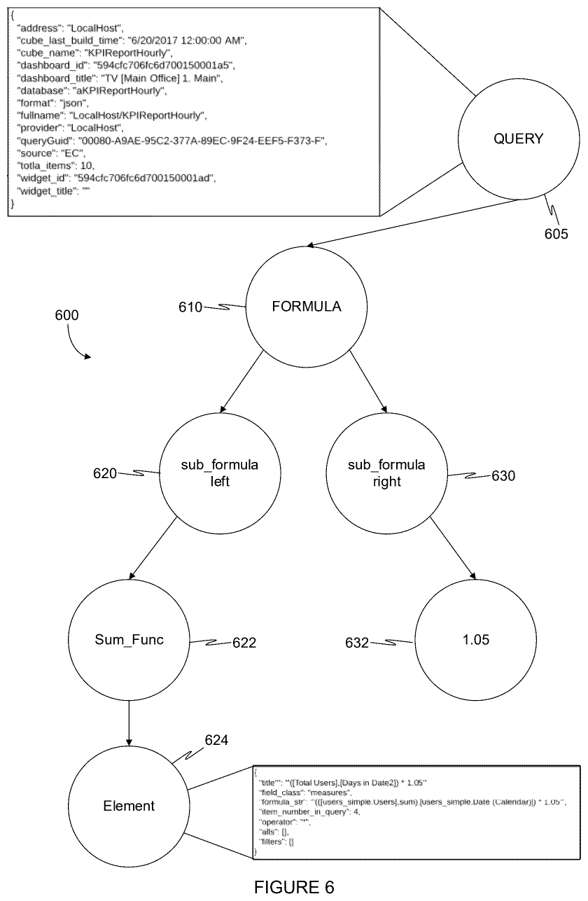

FIG. 6 is an example flow diagram 600 utilized to describe a query graph structure generated by a parser for a semantic knowledge graph generator.

A formula 610 is identified from a query 605. The formula 610 includes a left sub-formula 620 and a right sub-formula 630. The left sub-formula 620 includes a SUM function 622, which itself includes a data element 624. The right sub-formula 630 includes a textual object 632. Each identified object shown in FIG. 6 has at least one relationship with another object.

In an embodiment, the query graph structure is provided as an input for the graph generator 430 of FIG. 4. The graph generator 430 is configured, according to an embodiment, to incorporate the information of the query graph structure into a larger graph stored therein. One method of incorporating includes determining if an object of the query graph structure exists in the larger graph and, if not, adding the object to the larger graph. Addition can be based on a relationship to another object which is a part of the larger graph that also appears in the query graph structure.

Another method of incorporation may include determining that a first object and second object exist in both the query graph structure and the larger graph and determining the relationship between the first and second object. If a new relationship is found, the new relationship may be added to the larger graph. If an existing relationship is found, the weight of the relationship between the two objects may be increased. Updating the graph may include, but is not limited to, re-generating the query graph structure, using all previous inputs, or combining previous inputs with new inputs (i.e. new objects, new relations, and combinations thereof).

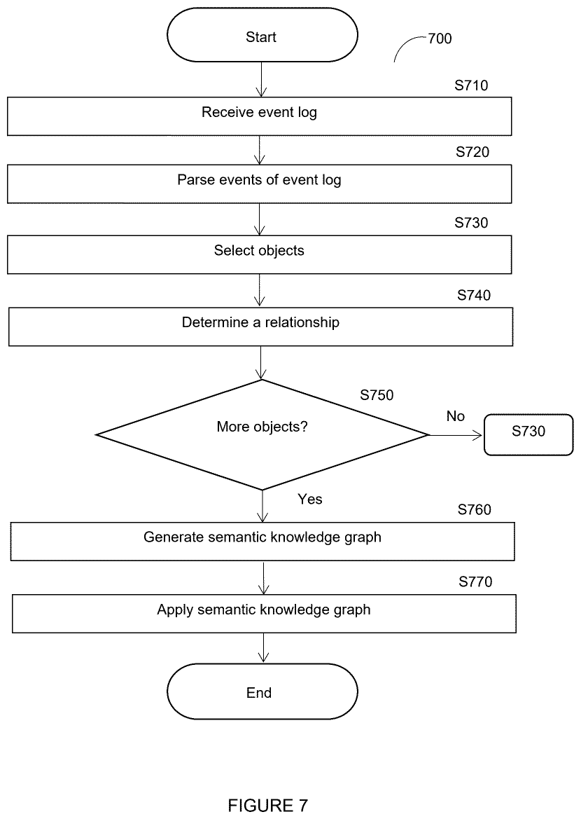

FIG. 7 is a flowchart 700 illustrating a method for generating a semantic knowledge graph from an event log of a BI system according to an embodiment. In an embodiment, the method is performed by the system 400 of FIG. 4.

At S710, an event log is received. The event log includes a plurality of events and may be continuously updated. In some embodiments, an initial event log is received, and thereafter events are received either as they occur, periodically, or both. For example, when there is a high volume of events, the events may be received periodically; and when there is a low volume of events, the events may be received as they occur. Events may be instructions related to loading a dashboard, loading a widget, executing one or more queries on one or more data sources, changing a filter on a query, changing a view of a widget, and the like.

At S720, each event of the received event log is parsed to identify objects and relations of those objects to one another. A parsed event may include, but is not limited to, a plurality of query objects and relations thereof. In some embodiments, objects may be further associated with metadata of a columnar relational database. The metadata may be received from a BI system, or by requesting the metadata from the data sources.

At S730, objects are selected from among the identified objects in the parsed event(s). In some embodiments, multiple objects are received and every possible relationship between each pair of two objects from among the objects is determined. Each relationship is further associated with a weight, which is increased based on a number of appearances in a parsed event.

At S740, a relationship is determined between at least a first object and a second object among the identified objects. In some embodiments, the first object, second object, or both, may each have relations to a plurality of other objects. In certain embodiments, the first object and second object may have a plurality of different relations to each other. For example, an object “SALARY_INCOME” may have both a “SUM” and an “AVG” (average) relationship to an object “INVESTMENT_INCOME,” depending on the query being executed.

At S750, it is determined if additional objects should be added to the model and, if so, execution continues with S730; otherwise, execution continues with S760. The semantic model may be stored in a memory of a user device, at a network accessible storage device, and the like.

At S760, a semantic knowledge graph is generated (or updated, if one already exists) based on the determined relationships between objects. Generating the semantic knowledge graph may include determining a plurality of query objects and the identified relations between them. In some embodiments, a semantic knowledge graph is generated by identifying a plurality of query objects and generating all possible relations between them. Weights are added to the relations based on the determined relations from the parsed events.

In some embodiments, a semantic knowledge graph may be generated based on a user account. In such embodiments, it may be further useful to determine a link between a user account and each event of the parsed event log, and to only input the parsed events which are linked to the user account into the semantic model.

In some embodiments, a general semantic model is generated for a group of users, which possibly have a dashboard or widget as a common feature. The general semantic model (also referred to as organizational memory model) may include identified objects and relations between the objects, each relationship further carrying a weight. A copy of the organizational memory model may then be associated with a user account and updated by only parsing events which pertain to the user account without changing the original organizational memory model.

The original organizational memory model may be continuously updated by inputting events from all users such that when a new user joins the organization (i.e., a group of users), the new user is presented with a seeded model, which may be customized to the user's needs over time based on use of the model by the user. As a non-limiting example, two users are presented with a copy of a first organizational memory model. Each user, through use, adapts the model (i.e. causes changes to weights of query object relationships) to their usage pattern. The first user adds an object to their copy of the organizational model which the second user does not use, and is therefore not present in the second user's model. However, by continuously updating the first organizational memory model, the added object is present in the model when a third user joins the group, providing the third user with a more enriched model, and therefore more potential to gain insights from data. In some embodiments, individual user models may be updated based on a current version of the general organizational memory model.

In certain embodiments, a node, a relation, or both, may be culled from a semantic knowledge graph. Culling may be done based on, for example but not limited to, frequency of use, values of weights (e.g., relationships having weights below a threshold may be culled), vector distance (e.g., relationships having vector distances exceeding a threshold may be culled), combinations thereof, and the like. The culling may be performed periodically.

In some embodiments, it may be advantageous to maintain snapshots of a semantic model to allow for reverting changes. Snapshots can be stored, for example, periodically. Multiple snapshots may be maintained, for example, for personalized models associated with different user accounts, for the original model, or both. Snapshots may also be stored in response to certain changes of the model. As a non-limiting example, adding or culling a node may trigger storing a snapshot while changing a weight of a relation, adding a relation, or removing a relation, may not.

At optional S770, the semantic knowledge graph is applied. Applying the semantic knowledge graph includes determining one or more outputs based on the organization of the semantic knowledge graph. Such outputs may include, but are not limited to, suggested fields, widgets in reports, user profiles or portions thereof, cache contents to be used for cache warmups, and the like.

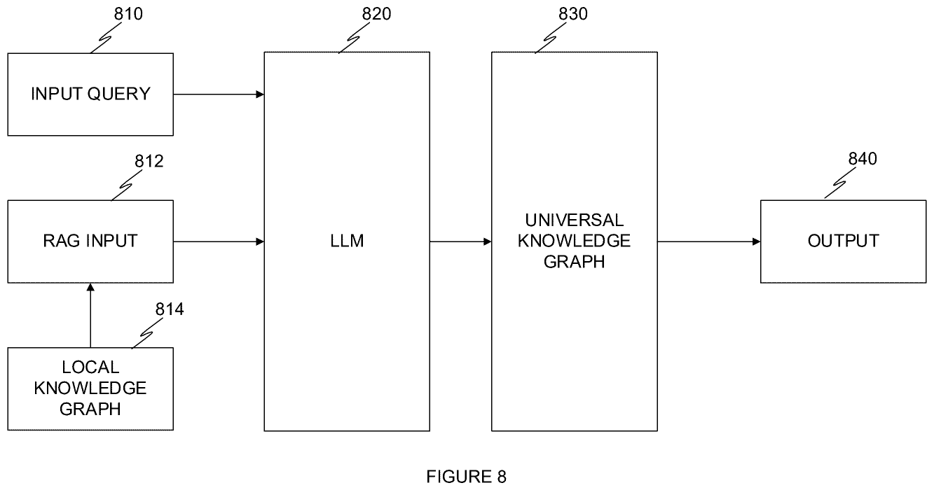

FIG. 8 is a diagram of a fine-tuned LLM for generating a response to a data query, implemented in accordance with an embodiment. In an embodiment, an LLM 820 is configured to receive an input 810 for processing. In some embodiments, the input 810 is an input query. In an embodiment, an input query includes a structured query (e.g., a SQL query), an unstructured query (e.g., a natural language query), a combination thereof, and the like.

According to an embodiment, the input 810 is processed into a prompt which is processed by the LLM 820. In an embodiment, the prompt is generated based on a predefined template. For example, in an embodiment, an LLM 820 is provided with an input 810 as an input query, and an input prompt template.

In some embodiments, the LLM 820 is configured to receive a retrieval augmented generation (RAG) input 812. In some embodiments, the RAG input 812 is a local knowledge graph 814 of a specific computing environment, specific customer, etc. In an embodiment, a specific computing environment refers to an environment of user accounts which are authorized to access data (e.g., view, manipulate, etc. data) and data sources which generate, provide, etc., the data.

In certain embodiments, the LLM 820 includes a plurality of neurons arranged in layers. In an embodiment, an output layer of the LLM 820 is fine-tuned based on the universal knowledge graph 830. In an embodiment, the universal knowledge graph 830 is generated based in part on the local knowledge graph 814.

In an embodiment, fine-tuning the LLM 820 based on the universal knowledge graph 830 includes adapting a weight associated with a neuron of the output layer of the LLM 820. In some embodiments, the weight is adapted, updated, set, stored, etc., based on a weight of an edge in the universal knowledge graph.

In some embodiments, the LLM 820 is a transformer model, such as a GPT, a BERT model, a LLAMA model, and the like. In an embodiment, the LLM query engine of FIG. 1B includes an LLM 820 which is fine-tuned based on the universal knowledge graph 830.

According to an embodiment, the fine-tuned LLM 820 is configured to process the input 810 and generate an output 840. In an embodiment, processing the input 810 includes processing a prompt based on a context window of data. In an embodiment, the context window has a fixed length.

In some embodiments, the output is a response to a query of the input 810. In certain embodiments, a plurality of LLMs are fine-tuned based on the universal knowledge graph 830. In an embodiment, a first LLM is of a first type (e.g., GPT) and a second LLM is of a second type (e.g., BERT). In an embodiment, each LLM of a plurality of LLMs is configured to process the input 810 to produce an output.

In certain embodiments, a plurality of outputs are generated, each output corresponding to a unique prompt, corresponding to a unique LLM, unique type of LLM, a combination thereof, and the like. In an embodiment, a match is performed between the plurality of outputs. In some embodiments, the outputs are vectorized and a match is determined by determining a vector distance between the vectorized outputs. In an embodiment, where the distance is below a threshold, the outputs are determined to be matching.

In an embodiment, an output 840 is provided in response to determining that a vector distance between two vectorized outputs is below a predetermined threshold. In an embodiment, where the distance is above a predetermined threshold, a notification is generated to request a new query.

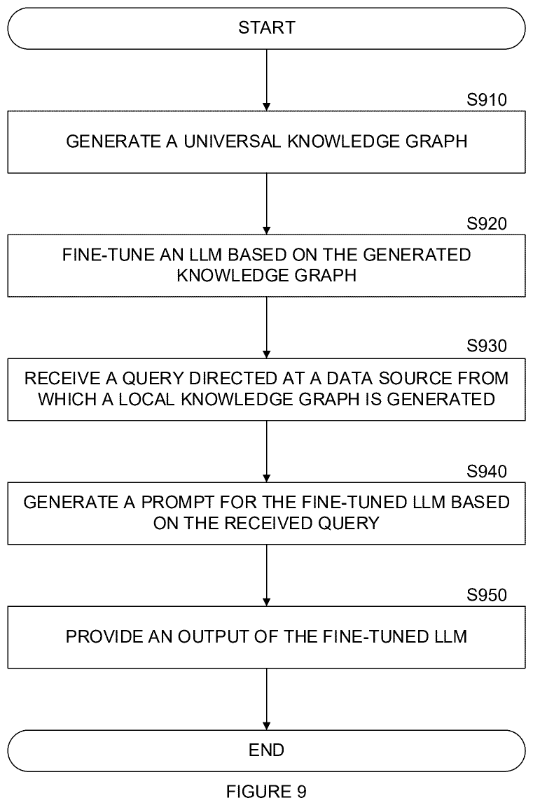

FIG. 9 is a flowchart of a method for generating a query response utilizing a fine-tuned LLM, implemented in accordance with an embodiment. In an embodiment, the LLM is provided with both a fine-tuning based on a universal knowledge graph, and a RAG input based on a local knowledge graph. By utilizing both, an accuracy of output is achieved, also reducing hallucination outputs, according to an embodiment.

At S910, a universal knowledge graph is generated. In an embodiment, the universal knowledge graph is generated utilizing the methods described in more details herein. In an embodiment, generating a universal knowledge graph includes generating a plurality of local knowledge graphs. In some embodiments, each local knowledge graph is generated based on data sources, metadata of the data sources, queries, interactions, events, and the like, from a computing environment.

According to some embodiments, a first local knowledge graph is generated respective of a first computing environment, and a second local knowledge graph is generated respective of a second computing environment. In an embodiment, a computing environment includes a cloud computing environment, an on-prem computing environment, a networked computing environment, a hybrid computing environment, a combination thereof, and the like.

In certain embodiments, a computing environment is associated with a single tenant, such as a single customer, single account, etc. In an embodiment, a single tenant, single customer, single account, etc., is associated with a plurality of user accounts, service accounts, a combination thereof, and the like.

At S920, an LLM is fine-tuned. In an embodiment, the LLM includes a general purpose LLM which is trained on a corpus of data which is not domain specific. For example, GPT, BERT, LLAMA, and the like, include model versions which are not trained for a specific domain.

In an embodiment, the LLM is fine-tuned based on the universal knowledge graph. According to an embodiment, fine-tuning an LLM includes adapting a weight associated with a neuron, for example of an output layer. In some embodiments, the LLM includes a plurality of neurons, at least a portion of which are associated with an input layer, and another portion of which are associated with an output layer.

According to some embodiments, fine-tuning an LLM includes adapting, changing, writing, etc., a weight, a plurality of weights, and the like, associated with an output layer neuron of the LLM.

In an embodiment, the weight associated with the neuron of the output layer of the LLM is adapted based on a weight of an edge of the universal graph. For example, in some embodiments, the weight of the edge is a weight of an edge connecting a first node and a second node in the universal knowledge graph.

At S930, a query is received. In an embodiment, the query is a structured query, an unstructured query, a combination thereof, and the like. For example, in an embodiment, a structured query is a SQL query. In some embodiments, an unstructured query is a natural language query.

In some embodiments, the received query is directed to a data source of the computing environment. In an embodiment, the received query is tokenized. In some embodiments, the received query is utilized to modify, alter, change, etc., a predefined prompt template.

In an embodiment, the query is received from a user device, user account, and the like, and includes an identifier of a user account, service account, etc., which is associated with the request. In some embodiments, the user account is associated with a permission, for example a permission to view certain data. In an embodiment, a check is performed, for example with an identity and access management system, to determine if the user account is authorized to view data which is presented as a result of the query.

At S940, a prompt is generated. In an embodiment, the received query is utilized to modify, alter, change, etc., a predefined prompt template. In some embodiments, the prompt is generated by the LLM.

For example, in an embodiment, a first prompt includes the received query and a prompt template, and a second prompt is generated based on processing the first prompt. For example, the LLM is configured to output the second prompt, which is based on the received query and the prompt template. In an embodiment, the second prompt, when processed, outputs a result to the received query.

In an embodiment, the prompt includes a RAG input, such as a local knowledge graph. In some embodiments, a computing environment includes a plurality of local knowledge graphs. For example, in an embodiment, a computing environment includes a primary knowledge graph, which is generated based on a plurality of secondary knowledge graphs. In an embodiment, each secondary knowledge graph is associated with a user account, a role, a user group, and the like.

In such an embodiment, the plurality of secondary knowledge graphs are generated based on queries related to a specific identity, data which is viewable by the entity, etc., and a primary local knowledge graph is generated based on a plurality of secondary knowledge graphs. In an embodiment, a universal knowledge graph is generated based on a plurality of primary local knowledge graphs, a plurality of local knowledge graphs, a combination thereof, and the like.

At S950, the output is provided. In an embodiment, an output of the LLM includes a response to the received query. In some embodiments, for example when a plurality of outputs are generated, a single output is selected for provisioning.

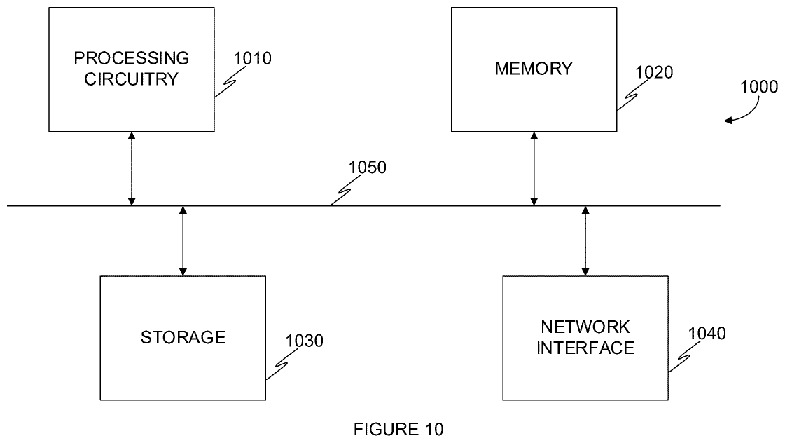

FIG. 10 is an example schematic diagram of an LLM query engine 1000 according to an embodiment. The LLM query engine 1000 includes, according to an embodiment, a processing circuitry 1010 coupled to a memory 1020, a storage 1030, and a network interface 1040. In an embodiment, the components of the LLM query engine 1000 are communicatively connected via a bus 1050.

In certain embodiments, the processing circuitry 1010 is realized as one or more hardware logic components and circuits. For example, according to an embodiment, illustrative types of hardware logic components include field programmable gate arrays (FPGAs), application-specific integrated circuits (ASICs), Application-specific standard products (ASSPs), system-on-a-chip systems (SOCs), graphics processing units (GPUs), tensor processing units (TPUs), Artificial Intelligence (AI) accelerators, general-purpose microprocessors, microcontrollers, digital signal processors (DSPs), and the like, or any other hardware logic components that are configured to perform calculations or other manipulations of information.

In an embodiment, the memory 1020 is a volatile memory (e.g., random access memory, etc.), a non-volatile memory (e.g., read only memory, flash memory, etc.), a combination thereof, and the like. In some embodiments, the memory 1020 is an on-chip memory, an off-chip memory, a combination thereof, and the like. In certain embodiments, the memory 1020 is a scratch-pad memory for the processing circuitry 1010.

In one configuration, software for implementing one or more embodiments disclosed herein is stored in the storage 1030, in the memory 1020, in a combination thereof, and the like. Software shall be construed broadly to mean any type of instructions, whether referred to as software, firmware, middleware, microcode, hardware description language, or otherwise. Instructions include, according to an embodiment, code (e.g., in source code format, binary code format, executable code format, or any other suitable format of code). The instructions, when executed by the processing circuitry 1010, cause the processing circuitry 1010 to perform the various processes described herein, in accordance with an embodiment.

In some embodiments, the storage 1030 is a magnetic storage, an optical storage, a solid-state storage, a combination thereof, and the like, and is realized, according to an embodiment, as a flash memory, as a hard-disk drive, another memory technology, various combinations thereof, or any other medium which can be used to store the desired information.

The network interface 1040 is configured to provide the LLM query engine 1000 with communication with, for example, the BI system 520, data sources 530, computing environment 150, universal knowledge graph store 110, a combination thereof, and the like, according to an embodiment.

It should be understood that the embodiments described herein are not limited to the specific architecture illustrated in FIG. 10, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer-readable medium consisting of parts, or of certain devices and/or a combination of devices. The application program may be uploaded to, and executed by, a machine comprising any suitable architecture. Preferably, the machine is implemented on a computer platform having hardware such as one or more processing units (“PUs”), a memory, and input/output interfaces. The computer platform may also include an operating system and microinstruction code. The various processes and functions described herein may be either part of the microinstruction code or part of the application program, or any combination thereof, which may be executed by a PU, whether or not such a computer or processor is explicitly shown. In addition, various other peripheral units may be connected to the computer platform such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for providing query responses from a big data system utilizing a knowledge graph, comprising:
generating a plurality of local knowledge graphs, each local knowledge graph of the plurality of local knowledge graphs generated respective of a unique plurality of data sources;
generating a universal knowledge graph based on the generated plurality of local knowledge graphs;
fine-tuning a large language model (LLM) based on the generated universal knowledge graph;
receiving a query directed at a data source of the plurality of unique data sources of a first local knowledge graph;
generating a prompt for the LLM based on the received query; and
processing the prompt utilizing the LLM to generate an output, wherein the output is a response to the received query.

2. The method of claim 1, further comprising:
generating the first local knowledge graph of the plurality of local knowledge graphs based on a first plurality of queries directed to the unique plurality of data sources of the first local knowledge graph;
generating a second local knowledge graph of the plurality of local knowledge graphs based on a second plurality of queries directed to the unique plurality of data sources of the second local knowledge graph.

3. The method of claim 1, further comprising:
generating the prompt further based on the first local knowledge graph.

4. The method of claim 3, wherein the prompt is generated using a retrieval augmented generation (RAG) technique.

5. The method of claim 1, further comprising:
adapting a weight of an output layer neuron of the LLM based on a weight of a node of the universal knowledge graph.

6. The method of claim 1, further comprising:
fine-tuning a second LLM based on the generated universal knowledge graph, wherein the second LLM is different from the LLM;
processing the prompt utilizing the second LLM to generate a second output;
comparing the output to the second output to determine a difference value; and
providing the output in response to determining that the difference value is below a threshold value.

7. The method of claim 6, further comprising:
generating a request for a new query, in response to determining that the difference value is above a threshold value.

8. The method of claim 1, further comprising:
continuously updating the universal knowledge graph; and
continuously fine-tuning the LLM based on the continuously updated universal knowledge graph.

9. The method of claim 1, further comprising:
accessing a new plurality of unique data sources;
extracting metadata from each unique data source of the new plurality of unique data sources;
generating a prompt for the LLM based on the extracted metadata, which when processed by the LLM outputs a shared data model for the new plurality of unique data sources.

10. A non-transitory computer-readable medium storing a set of instructions for providing query responses from a big data system utilizing a knowledge graph, the set of instructions comprising:
one or more instructions that, when executed by one or more processors of a device, cause the device to:
generate a plurality of local knowledge graphs, each local knowledge graph of the plurality of local knowledge graphs generated respective of a unique plurality of data sources;
generate a universal knowledge graph based on the generated plurality of local knowledge graphs;
fine-tune a large language model (LLM) based on the generated universal knowledge graph;
receive a query directed at a data source of the plurality of unique data sources of a first local knowledge graph;
generate a prompt for the LLM based on the received query; and
process the prompt utilizing the LLM to generate an output, wherein the output is a response to the received query.

11. A system for providing query responses from a big data system utilizing a knowledge graph comprising:
one or more processors configured to:
generate a plurality of local knowledge graphs, each local knowledge graph of the plurality of local knowledge graphs generated respective of a unique plurality of data sources;
generate a universal knowledge graph based on the generated plurality of local knowledge graphs;
fine-tune a large language model (LLM) based on the generated universal knowledge graph;
receive a query directed at a data source of the plurality of unique data sources of a first local knowledge graph;
generate a prompt for the LLM based on the received query; and
process the prompt utilizing the LLM to generate an output, wherein the output is a response to the received query.

12. The system of claim 11, wherein the one or more processors are further configured to:
generate the first local knowledge graph of the plurality of local knowledge graphs based on a first plurality of queries directed to the unique plurality of data sources of the first local knowledge graph; and
generate a second local knowledge graph of the plurality of local knowledge graphs based on a second plurality of queries directed to the unique plurality of data sources of the second local knowledge graph.

13. The system of claim 11, wherein the one or more processors are further configured to:
generate the prompt further based on the first local knowledge graph.

14. The system of claim 13, wherein the prompt is generated using a retrieval augmented generation (RAG) technique.

15. The system of claim 11, wherein the one or more processors are further configured to:
adapt a weight of an output layer neuron of the LLM based on a weight of a node of the universal knowledge graph.

16. The system of claim 11, wherein the one or more processors are further configured to:
fine-tune a second LLM based on the generated universal knowledge graph, wherein the second LLM is different from the LLM;
process the prompt utilizing the second LLM to generate a second output;
compare the output to the second output to determine a difference value; and
provide the output in response to determining that the difference value is below a threshold value.

17. The system of claim 16, wherein the one or more processors are further configured to:
generate a request for a new query, in response to determining that the difference value is above a threshold value.

18. The system of claim 11, wherein the one or more processors are further configured to:
continuously update the universal knowledge graph; and
continuously fine-tune the LLM based on the continuously updated universal knowledge graph.

19. The system of claim 11, wherein the one or more processors are further configured to:
access a new plurality of unique data sources;
extract metadata from each unique data source of the new plurality of unique data sources; and
generate a prompt for the LLM based on the extracted metadata, which when processed by the LLM outputs a shared data model for the new plurality of unique data sources.
